(19) United States
(12) Patent Application Publication
(10) Pub. No.: US 2023/0109976 A1
(43) Pub. Date: Apr. 13, 2023

(54) ROBOTIC REPAR SYSTEMS AND METHOD

(71) Applicant: 3M INNOVATIVE PROPERTIES COMPANY, St. Paul, MN (US)

(72) Inventors: Aaron K. Nienaber, Lake Elmo, MN (US); Christie L. Vitale, Hudson, WI (US); Nathan J. Herbst, Woodbury, MN (US); Brett R. Hemes, Woodbury, MN (US); Thomas J. Strey, River Falls, WI (US); Jonathan B. Arthur, Hudson, WI (US); Mark W. Orlando, Chesterfield Township, MI (US)

(21) Appl. No.: 17/904,821

(22) PCT Filed: Feb. 19, 2021
(86) PCT No.: PCT/IB2021/051439

§ 371 Date: Aug. 23, 2022

Related U.S. Application Data
(60) Provisional application No. 62/981,059, filed on Feb. 25, 2020.

(51) Int. Cl. B25J 11/00; B24B 55/06; B25J 9/16; B25J 19/02; B24B 57/02

(52) U.S. Cl. CPC B25J 11/0065; B24B 55/06; B25J 9/1633; B25J 19/021; B24B 57/02

(57) ABSTRACT

A robotic repair unit (400) is presented that includes a removal tool (330, 425) coupled tot he robotic repair unit (400). The removal tool (330, 425) is configured to remove fluid or debris from a worksurface (130). The repair unit (400) also includes a controller (150) configured to control the robotic repair unit (400).

### BACKGROUND

Clear coat repair is one of the last operations to be automated in the automotive original equipment manufacturing (OEM) sector. Techniques are desired for automating this process as well as other paint applications (e.g., primer sanding, clear coat defect removal, clear coat polishing, etc.) amenable to the use of abrasives and/or robotic inspection and repair.

Prior efforts to automate the detection and repair of paint defects include the system described in US Patent Publication No. 2003/0139836, which discloses the use of electronic imaging to detect and repair paint defects on a vehicle body. The system references the vehicle imaging data against vehicle CAD data to develop three-dimensional paint defect coordinates for each paint defect. The paint defect data and paint defect coordinates are used to develop a repair strategy for automated repair using a plurality of automated robots that perform a variety of tasks including sanding and polishing the paint defect.

### BRIEF DESCRIPTION OF THE DRAWINGS

In the drawings, which are not necessarily drawn to scale, like numerals may describe similar components in different views. The drawings illustrate generally, by way of example, but not by way of limitation, various embodiments discussed in the present document.

FIGS. 1A and 1B are schematics of a robotic paint repair system in which embodiments of the present invention are useful.

FIGS. 2A-2G illustrate schematics of tool configurations for a robotic repair unit in accordance with embodiments herein.

FIG. 3 illustrates a method of detecting and repairing a defect on a work surface in accordance with embodiments herein.

FIG. 4 illustrates a robotic repair system in accordance with embodiments herein.

FIG. 5 illustrates a method of replacing a fluid remover in accordance with embodiments herein.

FIGS. 6-8 illustrate schematics of robotic surface preparation systems in which embodiments discussed herein may be useful.

### DETAILED DESCRIPTION

Recent advancements in imaging technology and computational systems has made feasible the process of clear coat inspection at production speeds. In particular, stereo deflectometry has recently been shown to be capable of providing images and locations of paint and clear coat defects at appropriate resolution with spatial information (providing coordinate location information and defect classification) to allow subsequent automated spot repair.

As defect detection and classification techniques improve, the ability to automate the repair of detected defects becomes possible. The automated repair process presents new challenges, including providing materials such as abrasive articles for sanding or polishing, fluids such as water for wet sanding or polish, and removing used materials and waste from the vehicle surface. Removal is important for post-repair inspection to ensure that a repair has been completed successfully. If the abrasive waste, and any fluids used in the repair process are not removed, the post-repair inspection process may not be accurate.

Described herein are some solutions for removing fluids from a repair area. Automated repair may benefit from fluids dispensed on or near a detected defect area. However, it is also important to have an automated removal solution for removing fluids, and waste created during the repair, from a repair surface so that the surface can be inspected for repair quality. A solution is desired that enables automated robot repair units to clean a repair surface area after a repair.

During a repair process, a surface defect may be sanded and polished. Both sanding and polishing may produce some swarf, or material removed from the work surface. Any fluids used during sanding or polishing operations, such as water, polish, or wax may mix with the swarf. A solution is needed that removes fluid and swarf from a worksurface.

As used herein, the term “vehicle” is intended to cover a broad range of mobile structures that receive at least one coat of primer, paint, or clear coat during manufacturing. While many examples herein concern automobiles, it is expressly contemplated that methods and systems described herein are also applicable to trucks, trains, boats (with or without motors), airplanes, helicopters, etc.

As used herein, the term “robotic repair unit” refers to a robotic repair system that interacts with a surface to remove a defect. The robotic repair unit may be a stationary unit, that operates on a stationary surface, in some embodiments. In other embodiments, the robotic repair unit is a mobile repair unit that can move along a rail, track, or other mechanism such that it can address a defect on a moving surface. Additionally, it is also possible that the repair unit is stationary and the subject of repair moves. The robotic repair unit may have one or more end effectors with one or more tools, such as those described in U.S. Provisional Patent Applications with Ser. Nos. 62/940,950 and 62/940,960, both filed Nov. 2, 2019, both herein incorporated by reference. However, other robotic repair unit constructions are also expressly contemplated.

Paint repair is one of the last remaining steps in the vehicle manufacturing process that is still predominantly manual. Historically this is due to two main factors: lack of sufficient automated inspection, and the difficulty of automating the repair process and post-repair inspection.

Progress has been made on the inspection portion, and with respect to the problem of abrading a surface to address a defect in a visually acceptable manner, as described in U.S. Provisional Patent Application with Ser. No. 62/941,286, filed Nov. 27, 2019. However, as automation progresses, additional problems have arisen, including how to provide abrasive materials, including abrasive articles, and fluids required for the abrading process, as well as how to remove or exchange used abrasive materials from the surface.

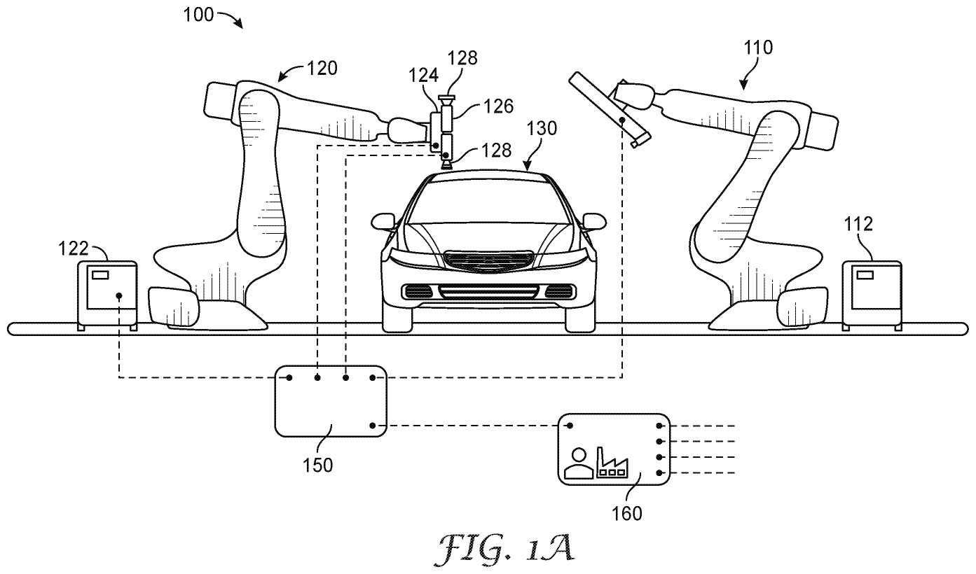

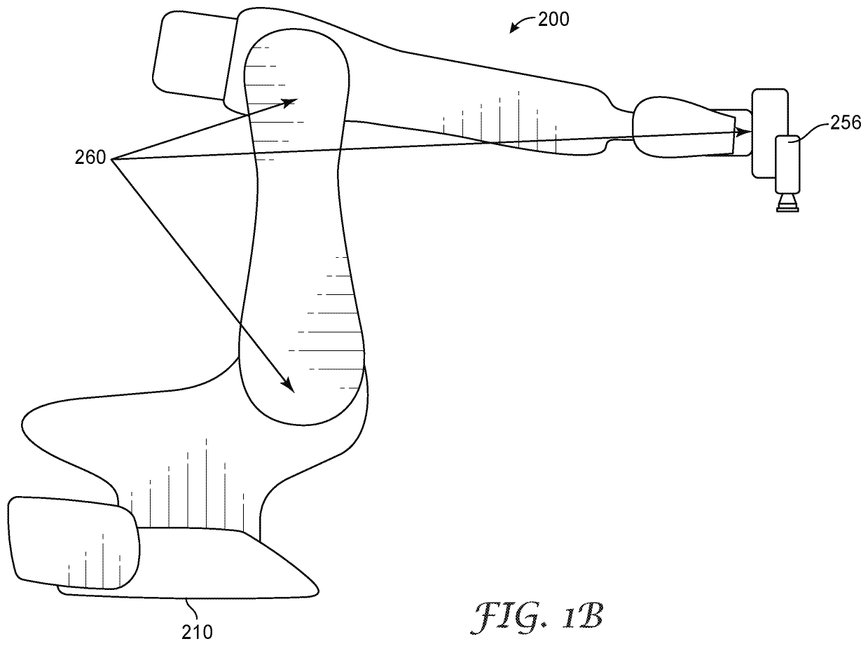

FIG. 1A is a schematic of a robotic paint repair system in which embodiments of the present invention are useful. System 100 generally includes two units, a visual inspection system 110 and a defect repair system 120. Both systems may be controlled by a motion controller 112, 122, respectively, which may receive instructions from one or more application controllers 150. The application controller may receive input, or provide output, to a user interface 160. Repair unit 120 includes a force control unit 124 that can be aligned with an end-effector 126. As illustrated in FIG. 1, end effector 126 includes two tools 128, which may be arranged, in one embodiment, as further described such as those described in U.S. Provisional Patent Applications with Ser. Nos. 62/940,950 and 62/940,960, both filed Nov. 2, 2019. However, other arrangements are also expressly contemplated. Visual inspection unit 110 may detect defects on a vehicle surface 130, which may be repaired by repair unit 120.

The presence of a sufficiently capable inspection system 110 is important for identifying and addressing defects for repair by repair unit 120. The current state of the art in vehicle paint repair is to use fine abrasive and/or polish systems to manually sand/polish out the defects, with or without the aid of a power tool, while maintaining the desirable finish (e.g., matching specularity in the clear coat). An expert human executing such a repair leverages many hours of training while simultaneously utilizing their senses to monitor the progress of the repair and make changes accordingly. Such sophisticated behavior is hard to capture in a robotic solution with limited sensing.

Additionally, abrasive material removal is a pressure-driven process while many industrial manipulators, in general, operate natively in the position tracking/control regime and are optimized with positional precision in mind. The result is extremely precise systems with extremely stiff error response curves (i.e., small positional displacements result in very large corrective forces) that are inherently bad at effort control (i.e., joint torque and/or Cartesian force)). Closed-loop force control approaches have been used (with limited utility) to address the latter along with more recent (and more successful) force-controlled flanges that provide a soft (i.e., not stiff) displacement curve much more amenable to sensitive force/pressure-driven processing.

Some repair processes use fluids to accelerate or otherwise aid the abrasive removal process. For example, fluid may assist in swarf removal, reduce abrasive clogging, and extend the life of the abrasive article while improving the consistency of cut during use. For example, some sanding operations are wet sanding operations, requiring water, or another fluid, to be dispersed on the repair area prior to, or during, an abrading operation. Additionally, polishing often requires polish to be dispensed before, or during, the polishing operation. Water, or another removal solvent, may be dispensed to remove debris after the repair is completed.

FIG. 1B is a schematic of a paint repair robot which may be useful in embodiments of the present invention. A robotic repair unit 200 has a base 210, which may be stationary, in some embodiments. In other embodiments, base 210 can move in any of six dimensions, translations or rotations about an x-axis, y-axis and/or z-axis. For example, robot 200 may have a base 210 fixed to a rail system configured to travel along with a vehicle being repaired. Depending on a defect location, robot 200 may need to move closer, or further away from a vehicle, or may need to move higher or lower with respect to the vehicle. A moveable base 210 may make repairing difficult-to-reach defects easier.

Robotic repair unit 200 has one or more tools 256 that can interact with a worksurface. Tool 256 may include a backup pad, in one embodiment, or another suitable abrasive tool. During an abrasive operation, tool 256 may have an abrasive disc, or other suitable abrasive article, attached using adhesive, hook and loop, clip system, vacuum or other suitable attachment system. As mounted to the robotic repair unit 200, tool 256 has the ability to be positioned within the provided degrees of freedom by the robotic repair unit 200 (6 degrees of freedom in most cases) and any other degrees of freedom (e.g., a compliant force control 230 unit) with its reference frame.

Robotic repair unit 260 has several joints 260, each of which can move in x and y directions, as illustrated in FIG. 1B. Additionally, in some embodiments where joints 260 are ball joints, they may each also allow for movement in a z direction. The ability of robotic repair unit to move is important, as it allows access to defects at different positions on a vehicle to be repaired. However, it does present difficulties when designing for fluid provision from an external source.

A solution is desired that can both dispense fluids onto a worksurface and remove fluids automatically. This allows for a repair process to proceed continuously from positioning an abrading tool near a defect, sanding the defect, polishing the defect, and cleaning the surface. A post-repair inspection may also occur automatically as soon as a repair process is completed.

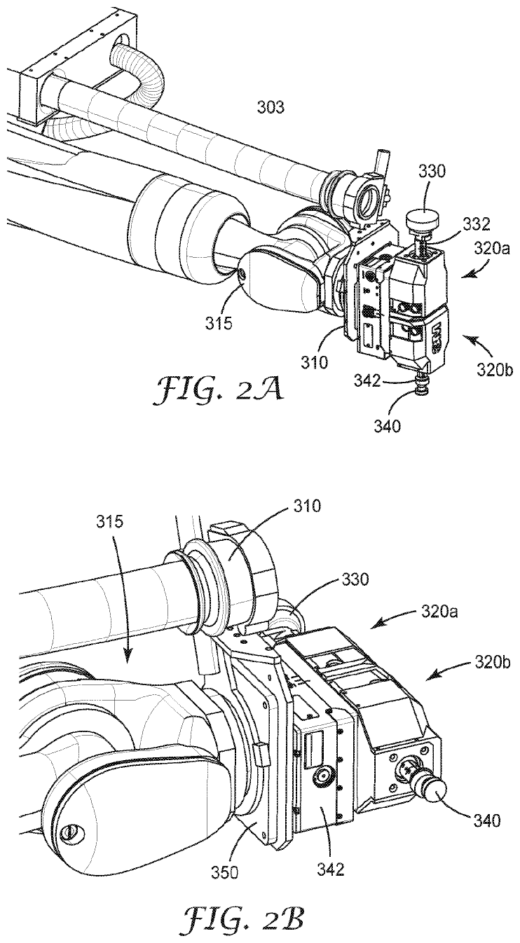

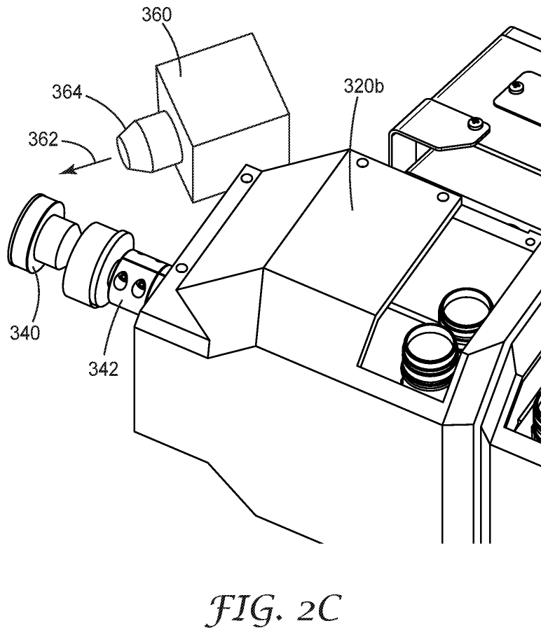

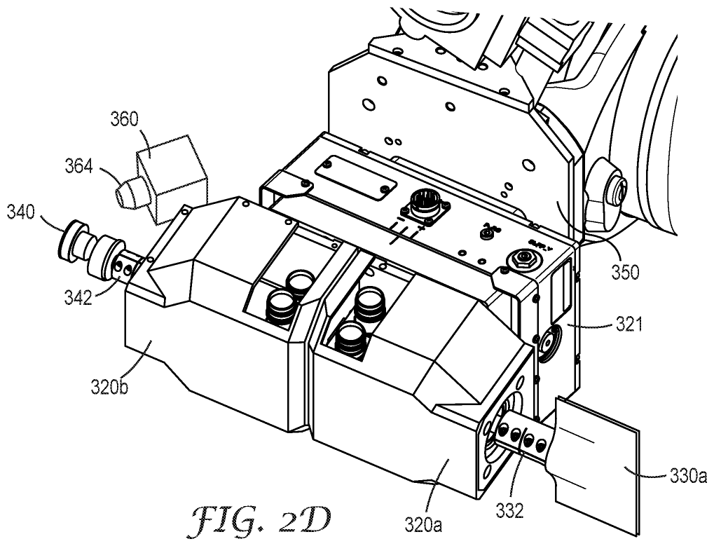

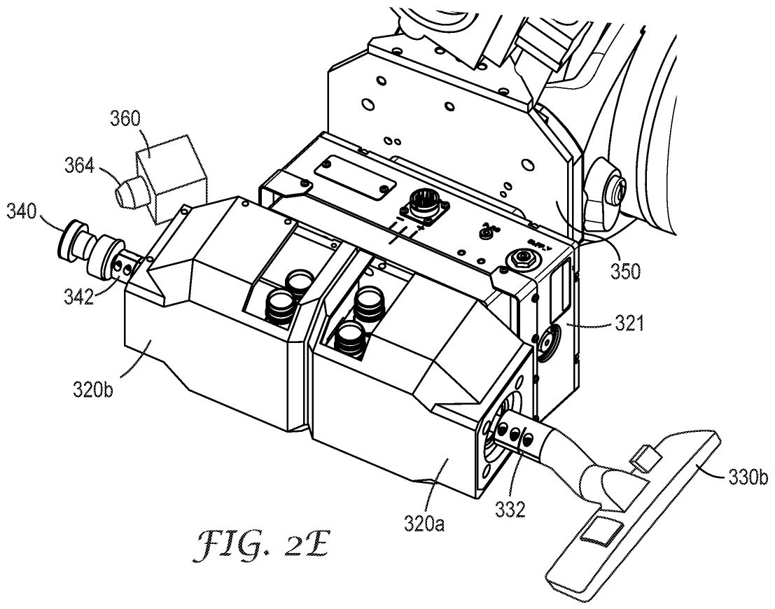

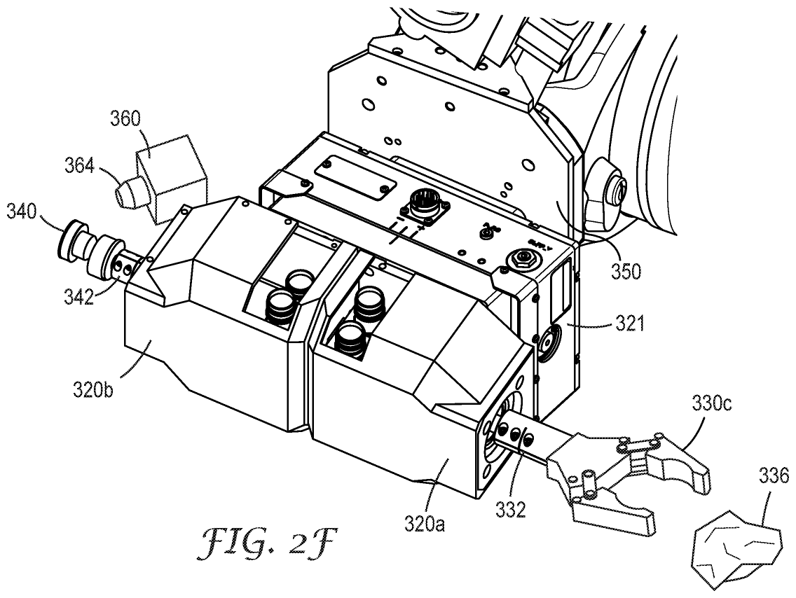

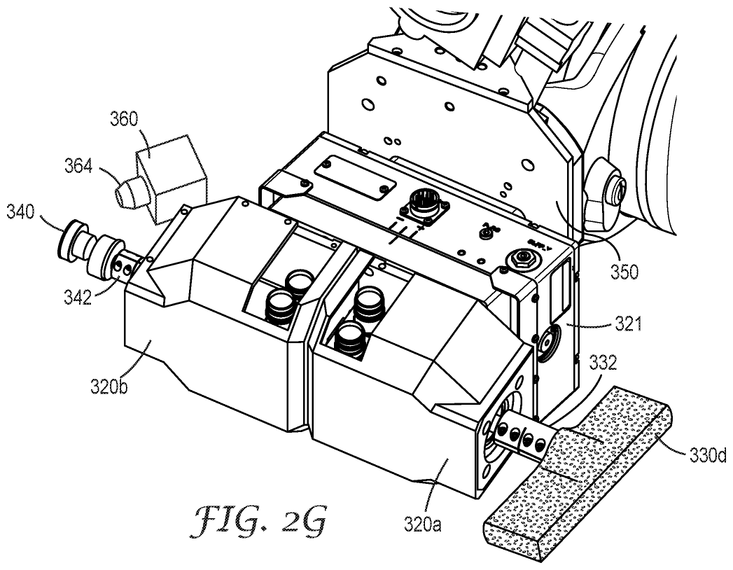

FIGS. 2A-2G illustrate tool configurations for a robotic repair unit which may be useful in embodiments herein. FIG. 2A illustrates a view of a two-tool end-effector system in a use-position. Robot arm 300 may have a cable mounting configuration 302. A robot arm 300 has a dual-mounted end effector system 320 mounted on a mounting plate 350. Robot arm 300 can move end effector system 320 rotationally, using rotational plate 310 and vertically, using joint 315, in order to place a first tool 330 or a second tool 340 in position to interact with a workpiece. Each of first and second tool 330, 340 have a connector 332, 342, respectively, that connects to an end effector unit 320a, 320b, respectively.

FIG. 2A illustrates end effector system 320 in one of two use positions, with second tool 340 in position to engage a workpiece. As discussed in U.S. Provisional Patent Application with Ser. No. 62/940,950, filed Nov. 2, 2019, a system 320 uses a single force control to operate both first and second tool 330, 340. First and second use position have one of tools 330, 340 aligned in parallel with force control. FIG. 2B illustrates a side-view of end effector system 320.

FIG. 2C illustrates a partial view of an end effector with a tool 340, coupled using connector 342, to an end effector unit 320b. Also mounted to end effector 320b is a fluid dispenser 360, which dispenses a fluid in direction 362 from a nozzle 364. However, while FIG. 2C illustrates one potential position of a fluid dispenser, other suitable positions are also contemplated.

FIGS. 2A-2C illustrate configurations of abrasive tools and fluid dispensers on a multi-tool end effector for a robotic repair system. However, while robotic repair systems such as those described in U.S. Provisional Patent Applications with Ser. Nos. 62/940,950, 62/940,960, both filed on Nov. 2, 2019, and 62/941,286, filed Nov. 27, 2019, illustrate how the fluid dispensing and abrading processes can be automated, there is a need for a robotic solution for removing fluid and abrasive debris, or swarf, from a work surface. And, as robotic operations are often conducted in a work area cordoned off from human operators, there is a need to provide a solution for clearing the post-repair surface of a vehicle so that inspection can occur without having to suspend robotic operations to allow for a human operator to act on the work surface.

FIGS. 2D-2G illustrate different configurations of a robotic solution for removing fluid and abrasive waste from a work surface after an abrasive operation. FIG. 2D illustrates a multi-tool end effector system with a tool 340 coupled to an end effector unit 320b through a connector 342. End effector unit 320a is connected to a wiping feature 330a. Wiping feature 330a is illustrated as a cloth, however it may be formed from a woven or nonwoven fabric or another absorbent material, such as a paper towel.

Wiping feature 330a is replaceable, in some embodiments, using any suitable mechanism. For example, wiping feature 33a may connect to connector 342 using a hook and loop configuration, adhesive, magnets, or another suitable temporary connection mechanism.

FIG. 2E illustrates a multi-tool end effector system with a fluid removal feature 330b coupled to end effector unit 320a through connector 332. Fluid removal feature 330b applies suction to a surface to suck up abrasive debris and any remaining fluid on a work surface. Fluid removal feature 330b may be coupled to a waste reservoir (not shown) that collects retrieved fluid and abrasive waste. While one suction-based removal feature 330b is illustrated, it is also envisioned that other suction-based features 330b are also possible. For example a flexible hose, or an inflexible tube may also be used. The suction-based feature may also include engagement features to improve suction efficiency, such as a rubber or other compressible portion along a surface-engaging edge of feature 330b.

FIG. 2F illustrates another embodiment of a fluid removal feature 330c. Unlike feature 330a, removal feature 330c does not require direct engagement between an absorbent article 336 and coupler 332, but instead acts as an intermediary, retrieving an absorbent article 336 for a fluid removal operation and disposing of a used absorbent article 336. Absorbent article 336 may be a single use article, or may have sufficient absorbent capacity for multiple fluid removal operations. Feature 330c may be a mechanical retrieval feature, such as the clamp illustrated in FIG. 2F. In other embodiments, feature 330c incorporates an engagement feature that retrieves absorbent article 336, such as a hook or loop attachment, an adhesive, a magnet, or another suitable engagement feature.

FIG. 2G illustrates another embodiment of a fluid removal feature 330d. Unlike feature 330a or 330c, fluid removal feature 330d may be used multiple times before replacement. Fluid removal feature 330d may be a compressible sponge or sponge-like element. In some embodiments, the illustrated sponge component 330d is combined with a suction component (not shown) and a fluid container (not shown).

While FIGS. 2D-2G illustrate a single tool option 340, it is expressly contemplated that other suitable tools are possible, in other embodiments. For example, an abrading tool 340 may include a sanding tool, a denibbing tool, or a polishing tool. Tool 340 may also couple to a backup pad and/or an abrasive article. Additionally, while fluid dispenser 360 is illustrated as coupled to end effector unit 320b, other positions are also possible, including on end effector unit 320a, on mounting plate 350, or another suitable position. For example, dispenser 360 may be positioned on the same end effector unit as a wiping feature, such that additional fluid can be dispensed to assist in removal of abrasive debris.

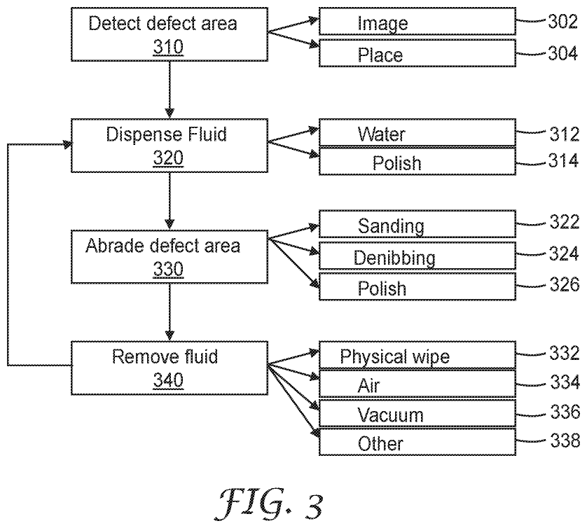

FIG. 3 illustrates a method of detecting and repairing a defect on a work surface in accordance with embodiments herein.

In block 310, a defect area is detected and instructions related to the detected defect are received by a repair unit from a robot controller, such as application controller 150 in FIG. 1A, for example. Without limitation to the embodiments discussed herein, the defect area can be detected by an image 302 of the surface or can be associated with a position on the vehicle, as indicated in block 304.

Blocks 320, 330, and 340 concern the steps of repairing a detected defect.

Defects may be repaired in one or more abrasive operations. For example, a defect area may first be sanded, then polished. A defect may be inspected in between the sanding and polish step and, depending on whether the defect was successfully repaired, the steps of sanding and/or polishing may be repeated.

In block 320, a fluid is dispensed onto a repair area. The fluid may be, for example, water 312 for a wet sanding or wet polishing operation. The fluid may also be, for a polishing operation, polish 314. Polish 314 may actually refer to a variety of polishes useful for different operations. Different polishes 314 may have different viscosities. Other fluids 316 may also be dispensed, depending on the repair operation. The fluid may be dispensed using a self-contained fluid dispensing system, such as those described in co-pending U.S. Provisional Application No. 62/981,058 any other suitable self-contained fluid dispensing system.

In block 330, the defect is abraded. Abrading a defect may include a sanding operation 322, a denibbing operation 324, a polishing operation 326, or another operation 328. Abrading the defect includes bringing a tool into contact with the defect area. Abrading may occur after, or simultaneously with the fluid dispensing of block 320.

In block 340, the fluid is removed from the work surface. Removing the fluid may also include removing waste produced from the abrasive operation, including clear coat or paint swarf. Removing fluid may be done manually, during a human inspection operation, or may be done automatically by a tool on the repair unit or by another robotic unit altogether. Fluid removal may include a physical wiping operation 332, with an absorbent article, using a blowing operation 334, a vacuum operation 336, or another suitable operation 338. The fluid removal element may be a single use element intended to be disposed after a single removal operation, in some embodiments. In other embodiments, the fluid removal element may be coupled to a fluid container where removed fluid is stored prior to periodic disposal. Alternatively, a fluid container may be coupled to a waste stream and removed fluid can be continuously removed. Additionally, removing a fluid as indicated in block 340 may refer to a combination of fluid removal elements, for example a sponge element coupled to a vacuum element to improve engagement with a work surface during suctioning. Additionally, compressed air or gas may be dispensed onto a work surface, as indicated in block 334, prior to a physical wiping operation. Fluid may also be simultaneously dispensed in order to assist in removal of swarf or higher viscosity fluids. For example, water may be dispensed in order to assist in removal of polish or wax.

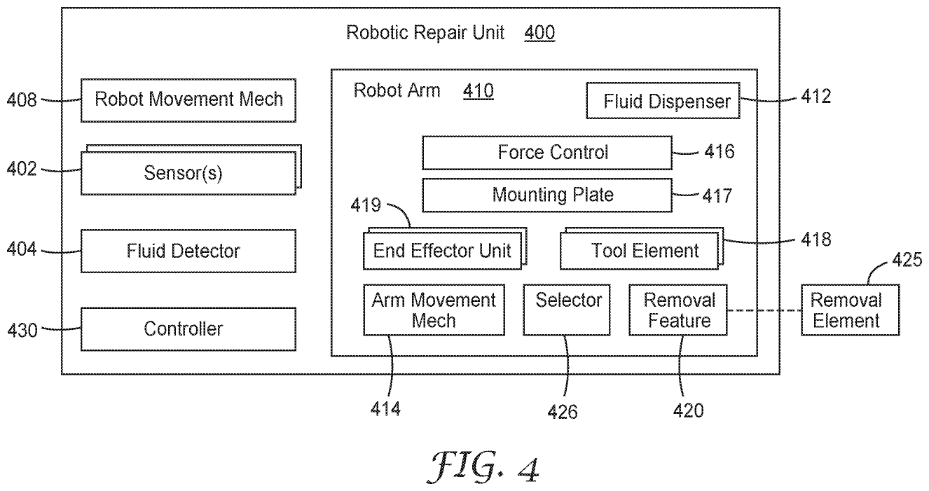

FIG. 4 illustrates a robotic repair system in accordance with embodiments herein. Robot 400 may have a robotic movement mechanism 408 that may allow for robot 400 to move, for example with respect to a vehicle being repaired. Robotic repair unit 400 also includes a controller 430 that may control movement of robot 400 and its components, either based on manual input or based on input received from sensors 402. Robot 400 may also include sensors specific to a fluid removal system, such as a fluid level detector 404 that detects whether a fluid container needs replacing, for example. Sensors may also be used to detect whether a fluid removal operation has been successful, e.g. whether a work surface is still wet or still has abrasive debris present. In some embodiments, sensors may be mounted separately from the robot 400, on the robot arm 410, or on an end effector assembly, for example.

Robot arm 410 has a force control element 416 coupled to a mounting plate 417. One or more end effector units 419 may also be coupled to mounting plate 417, and each end effector unit 419 may also be coupled to a tool element 418. One or more of the tool elements may be a removal feature 420. Removal feature 420 may be a single-use removal feature or may interact with a single-use removal element 425 using a selector 426 to sequentially select removal elements 425 for sequential removal operations. Robot arm 410 also has one or more robotic arm movement mechanisms 414 that allow for movement of one or more components of robotic arm 410.

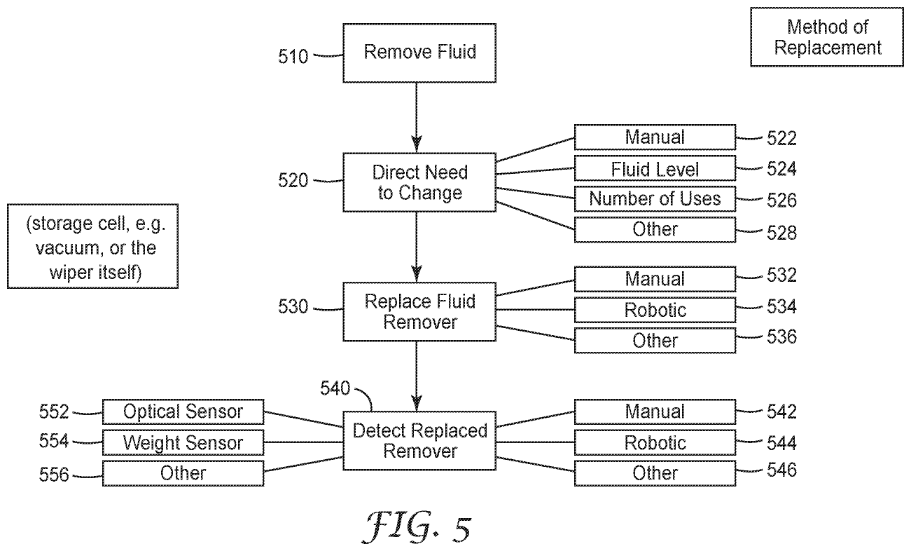

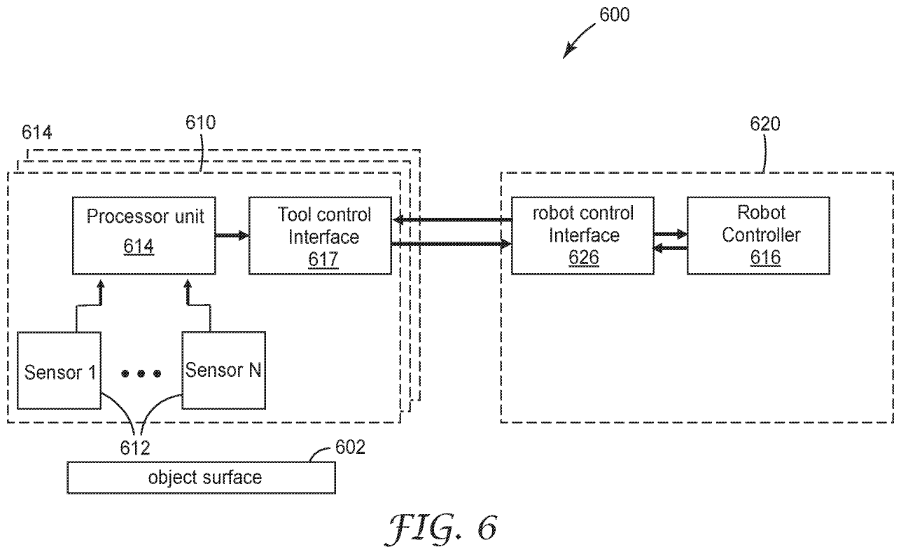

FIG. 5 illustrates a method of replacing a fluid remover in accordance with some embodiments herein. The system may include, for example, components similar to those described with respect to FIGS. 2A-2G, or other suitable robotic fluid removal systems. However, it may be necessary to replace a fluid removal component periodically. Some fluid removal components are single-use components, such as absorbent articles (e.g. single-use absorbent pads) and need to be replaced after each fluid removal operation. Other fluid-removal components can be used for several fluid-removal operations, such as high-absorbance articles (e.g. larger absorbent cloths, sponges, etc.), prior to removal. Other fluid-removal components do not need replacement themselves, but need a fluid container to be emptied periodically to continue successful removal.

In block 510, a fluid-removal operation is conducted. Fluid removal may include a physical wiping operation with an absorbent article, a suction operation, a blowing operation, a combination thereof, or another suitable operation.

In block 520, a need to replace a fluid removal feature is detected. In the case of single-use absorbent articles, detection can refer to a number of uses 524, e.g. each time that a removal operation is conducted, a removal feature must be replaced. For multi-use operations, the number of uses 524 may be greater than once, for example twice, three times, or more. Detecting a need to change may also be manually input, as indicated in block 522, for example as set by an operator. Detecting a need to change may also include detecting that a fluid level 526 has been reached. For example, an advantage of having a fluid removal solution coupled on a tool-side of a force control unit is an ability to detect slight changes in weight. For a multi-use absorbent article, detecting that a fluid level 526 has been reached may include detecting that the article weight has reached a level indicative of an inability to efficiently absorb more fluid. Additionally, detecting that a fluid level 526 has been reached may also include, for embodiments where a fluid container holds removed fluids, detecting that the fluid container has reached a level where the fluid remover will no longer be able to effectively remove additional fluid or debris. Other ways of detecting a need to change a fluid removal feature are also envisioned.

In block 530, the fluid removal feature is replaced. Replacement may include, for single-use articles, disposal of a used article and selection of a new absorbent article. This may be done by a robotic unit, as indicated in block 534, using a clamp or other tool to remove the used article, place the used article in a disposal unit, retrieve a new article, and place the new article on a receiver of the end effector unit. At least some part of replacement may be manual, as indicated in block 532. For example, a stack of single-use absorbent articles may be assembled and placed by an operator on an operator side of a robotic cell such that they are available for each replacement operation. Other replacement methods are also envisioned, as indicated in block 536. For example, replacement of a fluid container may be as simple as emptying the fluid container and replacing it. Alternatively, replacing the fluid container may include removing a full fluid container and placing an empty one in its place.

In block 540, the replaced fluid removal feature is detected. The robotic repair unit may detect that the removal feature has been replaced, in some embodiments. Replacement may be detected, for example, by an operator manually indicating the replacement, as indicated in block 542. Detecting a new fluid source unit may also include a weight sensor detecting that a tool-side weight corresponds to a new absorbent article or an empty fluid container, as indicated in block 544, for embodiments where weight sensing is feasible. Detecting the replaced fluid removal feature may also include other methods, as indicated in block 546, such as, for example, optically sensing that a new fluid container has been reinstalled. Other suitable sensing systems may also be feasible for other embodiments.

FIG. 6 illustrates a block diagram of a surface preparation system 600 including an end effector system 610 functionally connected to a motive robot arm 620 to prepare an object surface, according to one embodiment. As illustrated in FIG. 6, several end effector systems 610 can be coupled to a single robot arm 620. For example, two end effector systems 610 can be coupled to a force control such that each end effector system 610 is rotated 180° from the other. This allows a single force control to operate either end effect systems 610.

In another embodiment, more than two end effector systems 610 can be coupled to a single motive robot arm 620. For example, another set of end effector systems 610 can be mounted 180° from each other, and perpendicularly to the first set of end effector systems 610. A single force control can operate all four end effector systems by rotating 90° between each such that an end effector system 610 coupled to a tool of interest is in line with the force control.

Each end-effector 610 includes multiple sensors 612 (e.g., Sensor 1, . . . Sensor N) to detect its working state information with respect to the object surface 602. The multiple sensors 612 can include, for example, one or more of the pressure sensor 23 of FIG. 2, one or more of the flex sensor 24 of FIG. 2, one or more of the ultrasonic sensor 25 of FIG. 2, one or more of other types of sensors, and any combinations of the sensors. Raw signals (e.g. analog sensor signals) from the sensors 612 are received and processed by a processor unit 614 (e.g., the control circuit 28 of FIG. 2). The processor unit 614 may include an analog-to-digital converter (ADC) component to sample analog sensor signals and convert the analog sensor signals to digital signals. The processor unit 614 may further include a digital signal processing component to process and distill the digital signals to generate real-time tool state information, notifications, or instructions, and communicate the generated information to the robot controller and/or the force controller.

In some embodiments, the real-time tool state information generated by the processor unit 614 of the tool may include, for example, current position information of the tool with respect to the object surface. The real-time tool state information may further include, for example, a contact pressure indicating whether the tool contacting the object surface appropriately or not, a real-time change in the displacement between the object surface and the tool, etc.

In some embodiments, the processor unit 614 can combine positioning data from an ultrasonic sensor, surface mapping data from a flex sensor and pressure data from a pressure sensor the microcontroller to reconstruct the object surface 602 and derive a path for the end-effector tool to travel over the object surface 602 and prepare (e.g., scuff, abrade, sand, or polish) the object surface 602. In some embodiments, processing unit 614 only modifies an existing robot path to account for variation between the planned path and an actual position of the workpiece. In some embodiments, the real-time notifications generated by the processor unit 614 of the tool may include, for example, position notifications (e.g., a notification to the robot controller that the tool is at an edge of the object surface), safety notifications (e.g., a notification to the robot controller that the contact pressure is above an upper limit), etc.

In some embodiments, the instructions generated by the processor unit 614 of a tool may include, for example, a tool-operation instruction regarding how to control the operation of the tool, a locomotion instruction to instruct the robot controller to adjust the position of the tool, or the movement trajectory or velocity of the tool, etc. A tool-operation instruction may include, for example, an on/off instruction to the robot controller to turn on/off the tool, a motor control instruction to the robot controller to control the operation of a motor of the tool, etc. For example, the processor unit 614 may send an instruction to the robot controller to instruct the robot arm to move away from the object surface when the processor unit 614 determines that the contact pressure is above a limit. The processor unit 614 may send an instruction to the robot controller to instruct the robot arm to reduce the speed of the tool movement when the processor unit 614 determines that the tool is approaching the object surface. The processor unit 614 may send an immediate stop instruction to the robot controller to stop the operation of the tool when the processor unit 614 determines that there is a process event requiring immediate action or stoppage (e.g., the tool is contacted by an unidentified protrusion in the object surface).

The real-time state information, notifications, or instructions from the end-effector tool 610 can be sent to the robot controller 616 via the tool control interface 617 and the robot control interface 626. The robot controller 616 can then use the real-time state information to simultaneously update the locomotion parameters of the robot arm such that the movement trajectory of a end-effector tool can be precisely controlled. The robot controller 616 can also control the surface preparation system 600 accordingly by taking actions upon the notification or following the instructions from the end-effector tool 610. In some embodiments, the robot controller 616 may receive real-time state information, notifications, or instructions from the end-effector tool, interpret the received information, check whether the notifications or instructions are compatible with pre-set rules, and implement instructions correspondingly. For example, the robot controller 616 may provide the tool with a movement vector for the tool's position adjustment with respect to the object surface; the robot controller 616 may instruct the robot arm and/or force control unit to provide an appropriate force to press the tool against the object surface; the robot controller 616 can provide an immediate stop command to the tool to stop when an immediate condition is determined by the robot controller, etc.

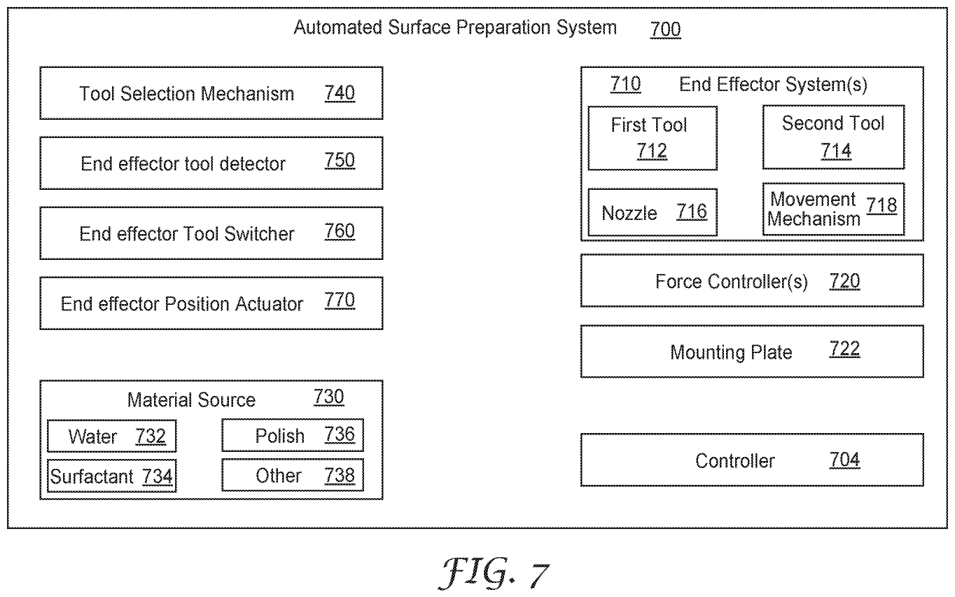

FIG. 7 illustrates a block diagram of an embodiment of dual-mounted end effector system. System 700 may be configured to connect to a motive robot arm, for example through mounting plate 722. In contrast to the robotic repair unit of FIG. 4, it is contemplated that a fluid removal tool can be part of a dual-mounted tool system, or a system with three, four, or more mounted tools. While a dedicated wiping tool is expressly contemplated, other configurations, such as that described in FIG. 7, are possible.

System 700 includes an end effector system 710. End effector system 710 is a dual-mount system that supports a first tool 712 and a second tool 714. In one embodiment, only one of first and second tools 712, 714 is operational at a time. In one embodiment, first and second tools 712, 714 are arranged such that the tools are rotationally 180° apart from one another. However, other configurations are also possible. Each of first and second tools 712, 714 may have associated sensors such as a pressure sensor, a flex sensor, an ultrasonic sensor or other suitable sensors for obtaining desired working state information.

System 710 also has one or more movement mechanisms 718 that allow for movement of tools 712, 714 into place with respect to work piece. In one embodiment, a tool 712 or 714 needs to be in line with, and parallel to, force control 720 to operate. Movement mechanism 718, in one embodiment, rotationally moves end effector system 710 such that either tool 712 or 714 is in place when needed. It is expressly contemplated, as discussed herein, that while two tools 712, 714 are discussed, that either tool 712 or tool 714 may be a waste removal feature.

System 700 includes a material source 730 configured to provide materials to a worksurface, for example using one or more nozzles 716. The provided materials may be, depending on an operation, water 732, surfactant 734, polish 736, or another suitable fluid 738, such as wax, for example.

In one embodiment, a tool selection mechanism 740 selects whether tool 712 or tool 714 should be aligned with force control 720. Tool selection mechanism 740 may make the selection in response to a user selection, for example through a user interface. Tool selection mechanism 740, in another embodiment, may make the selection based on parameters for a given repair. For example, based on a known defect, a first sanding tool may be needed, and then a polishing tool may be applied. Alternatively, after a sanding operation, a waste removal tool may be needed to remove produced swarf prior to polishing.

Tool selection mechanism 740, based on the repair process, may select the second appropriate tool when needed.

In one embodiment, end effector tool detector 750 is configured to detect a current tool in alignment with force control 720. End effector tool detector 750 may detect a current tool by detecting information from sensors associated with each of tool 712, 714.

For example, in one embodiment, each tool has an associated motor that may not be powered or otherwise in an ‘on’ state when not aligned with force control 720. Similarly, other sensor information may also be used to report whether a tool is in alignment. End effector tool detector may, therefore, detect if a tool is in alignment based on sensor and/or power usage information.

End effector tool switcher 760 may, based on whether, and which, a tool is in alignment with force control, generate a signal that end effector system 710 needs to change position in order for a desired tool to be in alignment with force control 720.

End effector position actuator 770 actuates movement mechanism 718 to cause a desired tool 712 or 714 to align with force control 720 for a desired operation.

A single end-effector system 710, with two tools 712 and 714 has been described. However, it is expressly contemplated that, in one embodiment, a second end effector system 710 is present, with a third and fourth tool. The third and fourth tool may also be positioned 180° with respect to each other. The second end-effector system 710 may be positioned at an offset with respect to the first system, with the offset being great enough that a first tool, when not in operation, does not affect operation of a third tool on a workspace. In one embodiment, the two systems 710 are positioned such that a rotation of movement mechanism 718 of about 90° results in one of the four tools being in alignment with force control 720. However, rotation between each of the four tools may require greater, or less, rotation depending on the size of the tool and clearance required to ensure that tools not in use do not inappropriately engage a work surface.

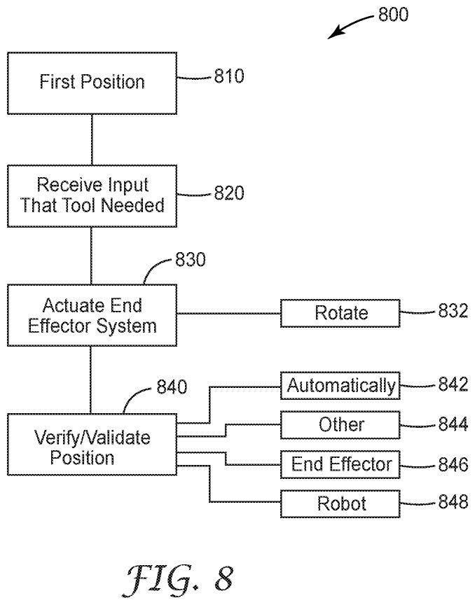

FIG. 8 illustrates a method of using a dual-mounted end effector in an embodiment of the present invention. Method 800 may be useful for any of the systems described with respect to FIGS. 3-7, or with another suitable dual-mounted end effector system.

In block 810, the end effector system is in a first position. The first position may be, for example, a first tool aligned with a force control.

In block 820, an input is received that a new tool is needed. The input may be received, for example, from an operator interacting with a user interface, in one embodiment. The input may come from, in another embodiment, from a set of repair instructions to be executed by an automated repair system. For example, after sanding and before polishing, the produced swarf may need to be removed by a waste removal tool.

In block 830, the end effector system is actuated. Actuation may include causing the end effector system to move from the first position to a second position, such that a tool is in alignment with a force control. In one embodiment, the end effector assembly comprises a first tool and a second tool, each mounted to the force control. In one embodiment, the first and second tools are positioned 180° apart from each other. Actuating the end effector system may, in such an embodiment, comprise rotating the end effector system until either the first or second tool is aligned with the force control.

In one embodiment, the end effector assembly comprises four tools, each mounted to a force control. In one embodiment, the four tools are oriented such that they are about 90° apart from one another. However, depending on the amount of space needed for a tool to operate freely, the tools may be closer or further apart. For example, two de-nibbing tools may be located more closely to one another than two sanding tools. The four tools may rotate such that each, in turn, aligns with a force control. In another embodiment, a four-tool end effector assembly requires two force controls, each with two tools positioned 180° apart, with the two force controls mounted perpendicularly to each other such that the four tools form a rough “X” shape.

In block 840, a tool position is validated. Validation may include ensuring that the tool is properly aligned with a force control. Validation may also include ensuring that the tool is properly connected to a motor. Validation may also include ensuring that sensors associated with the tool are all functioning properly. Validation may occur automatically, as indicated in block 842, or may include some operator intervention. Validation may be conducted by the end effector system, as indicated in block 846. Validation may also be conducted by a motive robot arm 848.

A robotic repair unit is presented that includes a removal tool coupled to the robotic repair unit. The removal tool is configured to remove fluid or debris from a worksurface. The robotic repair unit also includes a controller configured to control the robotic repair unit.

The robotic repair unit may be implemented such that it also includes a force control unit and an end effector coupled to the force control. The removal tool may be coupled to the end effector.

The robotic repair unit may be implemented such that the end effector is a first end effector unit. A second end effector unit is also coupled to the force control unit.

The robotic repair unit may be implemented such that it also includes an abrading tool coupled to the second end effector unit.

The robotic repair unit may be implemented such that the first end effector unit and the second end effector unit are mounted to a mounting plate which is mounted to the force control unit.

The robotic repair unit may be implemented such that the first end effector unit is mounted at least 10° away from the second end effector unit.

The robotic repair unit may be implemented such that the first end effector unit is mounted about 180° away from the second end effector unit.

The robotic repair unit may be implemented such that also includes a fluid dispenser mounted on the robotic repair unit.

The robotic repair unit may be implemented such that the fluid dispenser is mounted on the end effector.

The robotic repair unit may be implemented such that the fluid removal tool is a connector coupled to the end effector. The connector is configured to removably couple to a single-use fluid removal element.

The robotic repair unit may be implemented such that the single-use fluid removal element is a cloth or absorbent pad.

The robotic repair unit may be implemented such that the connector removably couples to the single-use fluid removal element using a hook and loop attachment system, an adhesive, or a magnet.

The robotic repair unit may be implemented such that the fluid removal tool includes a suction tool.

The robotic repair unit may be implemented such that the suction tool includes a flexible tube.

The robotic repair unit may be implemented such that the suction tool has an engagement feature to improve a seal to the worksurface.

The robotic repair unit may be implemented such that the fluid removal tool also includes a sponge element.

The robotic repair unit may be implemented such that the fluid removal tool includes a multi-use fluid removal element.

The robotic repair unit may be implemented such that the multi-use fluid removal element includes a sponge, absorbent cloth or absorbent pad.

The robotic repair unit may be implemented such that the fluid removal tool includes a blower.

The robotic repair unit may be implemented such that the blower directs compressed air at the work surface.

The robotic repair unit may be implemented such that it also includes a fluid detector configured to detect a fluid on the worksurface.

The robotic repair unit may be implemented such that it also includes a fluid removal replacement sensor configured to detect a need to replace a fluid removal component.

The robotic repair unit may be implemented such that the fluid removal component includes a fluid container storing removed fluid.

The robotic repair unit may be implemented such that the fluid removal replacement sensor is a weight sensor.

The robotic repair unit may be implemented such that the weight sensor is the force control unit.

The robotic repair unit may be implemented such that the fluid removal replacement sensor is an optical sensor.

The robotic repair unit may be implemented such that the fluid removal replacement sensor is a count of fluid removal operations for the fluid removal component.

The robotic repair unit may be implemented such that the removed fluid includes: water, polish, wax or swarf.

The robotic repair unit may be implemented such that the fluid dispenser dispenses fluid at least during part of an operation of the fluid removal tool.

The robotic repair unit may be implemented such that it also includes a robotic movement component. The worksurface may be a moving vehicle and the robotic movement component may be configured to move the robotic repair unit at a speed and a direction similar to the moving vehicle.

A method of repairing a defect on a worksurface is presented that includes bringing a robotic arm in proximity of the defect, causing an abrading tool, coupled to the robotic arm, into contact with a defect area containing the defect, abrading the defect area with the abrading tool. Abrading the area produces abrasive debris. The method also includes automatically removing the abrasive debris, using a robotic waste removal tool.

The method may be implemented such that the robotic waste removal tool is coupled to the robotic arm.

The method of may be implemented such that a robotic cell includes the robotic arm and the robotic waste removal tool.

The method may be implemented such that the waste removal tool removably couples to a single-use waste removal element.

The method may be implemented such that the single-use waste removal element includes an absorbent article.

The method may be implemented such that the absorbent article includes a woven article, a knit article, a nonwoven article, a spunlace article, a spunbond article, a stitchbond article, a melt blown article, a blown microfiber article, a microfiber or a sponge article.

The method may be implemented such that removably coupling includes the waste removal tool releasably attaching to the single-use waste removal element using a hook and loop attachment system, an adhesive, or a magnet system.

The method may be implemented such that the waste removal tool includes a suction tool.

The method may be implemented such that the waste removal tool includes a blower.

The method may be implemented such that the abrading tool is a sanding tool, a denibbing tool, or a polishing tool.

The method may be implemented such that the abrading tool couples to an abrasive article through a backup pad.

The method may be implemented such that the waste removal tool is coupled to a first end effector unit, which couples to a force control unit of the robotic arm.

The method may be implemented such that the abrading tool is coupled to a second end effector unit, which couples to the force control unit of the robotic arm.

The method may be implemented such that it also includes adjusting a relative position of the waste removal tool with respect to the defect area, such that the waste removal tool comes into proximity of the defect area.

The method may be implemented such that moving the waste removal tool into proximity causes the abrading tool to move away from the defect area.

The method may be implemented such that the first and second end effector units are both coupled to the force control through a mounting plate.

The method may be implemented such that the first end effector unit is mounted at least 90° from the second end effector unit.

The method may be implemented such that the first end effector unit is mounted about 180° from the second end effector unit.

The method may be implemented such that it also includes dispensing an abrading fluid on the defect area.

The method may be implemented such that the abrading fluid includes water, polish or wax.

The method may be implemented such that a fluid dispenser is coupled to the robotic arm.

The method may be implemented such that it includes dispensing fluid during the removal of abrasive waste.

The method may be implemented such that the fluid dispenser is coupled to the robotic arm.

The method may be implemented such that the fluid dispenser is coupled to an end effector unit to which the waste removal tool is coupled.

Reference throughout this specification to “one embodiment,” “certain embodiments,” “one or more embodiments,” or “an embodiment,” whether or not including the term “exemplary” preceding the term “embodiment,” means that a particular feature, structure, material, or characteristic described in connection with the embodiment is included in at least one embodiment of the certain exemplary embodiments of the present disclosure. Thus, the appearances of the phrases such as “in one or more embodiments,” “in certain embodiments,” “in one embodiment,” or “in an embodiment” in various places throughout this specification are not necessarily referring to the same embodiment of the certain exemplary embodiments of the present disclosure. Furthermore, the particular features, structures, materials, or characteristics may be combined in any suitable manner in one or more embodiments.

1. A robotic repair unit comprising:
a removal tool coupled to the robotic repair unit, wherein the removal tool is configured to remove fluid or debris from a worksurface; and
a controller configured to control the robotic repair unit.

2. The robotic repair unit of claim 1, and further comprising:
a force control unit; and
an end effector coupled to the force control, and wherein the removal tool is coupled to the end effector.

3. The robotic repair unit of claim 2, wherein the end effector is a first end effector unit, and wherein a second end effector unit is also coupled to the force control unit.

4. The robotic repair unit of claim 3, and further comprising an abrading tool coupled to the second end effector unit.

5. (canceled)

6. The robotic repair unit of claim 1, and further comprising a fluid dispenser mounted on the robotic repair unit.

7. The robotic repair unit of claim 1, wherein the fluid removal tool is a connector coupled to the end effector, wherein the connector is configured to removably couple to a single-use fluid removal element.

8. The robotic repair unit of claim 7, wherein the connector removably couples to the single-use fluid removal element using a hook and loop attachment system, an adhesive, or a magnet.

9. The robotic repair unit of claim 1, wherein the fluid removal tool comprises a suction tool or a blower.

10. The robotic repair unit of claim 9, wherein the fluid removal tool also comprises a sponge element.

11. (canceled)

12. (canceled)

13. The robotic repair unit of claim 1, and further comprising:
a fluid removal replacement sensor configured to detect a need to replace a fluid removal component.

14. (canceled)

15. The robotic repair unit of claim 13, wherein the fluid removal replacement sensor is a weight sensor.

16. (canceled)

17. The robotic repair unit of claim 13, wherein the fluid removal replacement sensor is an optical sensor.

18. The robotic repair unit of claim 13, wherein the fluid removal replacement sensor is a count of fluid removal operations for the fluid removal component.

19. (canceled)

20. A method of repairing a defect on a worksurface, the method comprising:
bringing a robotic arm in proximity of the defect;
causing an abrading tool, coupled to the robotic arm, into contact with a defect area containing the defect;
abrading the defect area with the abrading tool, wherein abrading the area produces abrasive debris; and
automatically removing the abrasive debris, using a robotic waste removal tool.

21. The method of claim 20, wherein the robotic waste removal tool is coupled to the robotic arm.

22-24. (canceled)

25. The method claim 20, wherein the waste removal tool comprises a suction tool or a blower.

26. (canceled)

27. The method of claim 20, wherein the waste removal tool is coupled to a first end effector unit, which couples to a force control unit of the robotic arm.

28. The method of claim 27, and further comprising:
adjusting a relative position of the waste removal tool with respect to the defect area, such that the waste removal tool comes into proximity of the defect area and wherein moving the waste removal tool into proximity causes the abrading tool to move away from the defect area.

29. (canceled)

30. The method of claim 29, wherein the first and second end effector units are both coupled to the force control through a mounting plate.

31. (canceled)

32. The method of claim 20, wherein the fluid dispenser is coupled to the robotic arm.
